(19) United States
(12) Patent Application Publication
(10) Pub. No.: US 2026/0324827 A1
(43) Pub. Date: Oct. 22, 2026

(54) PERSONAL CARRYING DEVICES

(71) Applicant: CTB Holdings LLC, Menlo Park, CA (US)

(72) Inventors: Thuan TRAN, San Jose, CA (US); Charlie CARROLL, Portola Valley, CA (US); Binh TRAN, San Jose, CA (US)

(73) Assignee: CTB Holdings LLC, Menlo Park, CA (US)

(21) Appl. No.: 19/727,815

(22) Filed: Jul. 1, 2026

Related U.S. Application Data
(62) Division of application No. 18/365,004, filed on Aug. 3, 2023, now Pat. No. 12,714,213.
(60) Provisional application No. 63/395,309, filed on Aug. 4, 2022.

(51) Int. Cl. A45C 13/02; A45C 1/06; A45C 13/18; A45F 5/02; E05B 67/06; F16B 45/02; A45F 5/00

(52) U.S. Cl. CPC A45C 13/023; A45C 1/06; A45C 13/185; A45F 5/021; E05B 67/06; F16B 45/022; A45C 2001/065; A45F 2005/002; A45F 2005/006; A45F 5/1558

(57) ABSTRACT

The disclosure includes a carrying device comprising a carabiner including a first clip and a second clip, wherein the first clip is configured to open to access a first chamber, and the second clip is configured to open to access a second chamber located adjacent the first chamber, and a shackle defining a first end and a second end located opposite the first end, wherein the first end is configured to detachably couple to the carabiner, and the second end is configured to receive at least one key.

### CROSS-REFERENCE TO RELATED APPLICATIONS

The present application is a divisional of U.S. Patent Application No. 18/365,004 filed on Aug. 3, 2023, which claims priority to U.S. Provisional Patent Application No. 63/395,309 filed on Aug. 4, 2022, entitled “PERSONAL CARRYING DEVICES” the contents of which are incorporated herein by reference in their entireties.

### BACKGROUND OF THE INVENTION

The purpose of a carabiner is to quickly and securely connect different objects or components together. Carabiners often consist of a metal loop with a spring-loaded gate that can be opened and closed. The gate allows for easy attachment and detachment of objects. They can be used for outdoor activities, such as rock climbing, and also for securing keys, water bottles, tools, and various accessories to backpacks, belts, or gear loops. Carabiners provide a convenient and reliable way to keep items easily accessible while on the move; however, the traditional carabiner design has some drawbacks that the present disclosure seeks to remedy.

### SUMMARY OF THE INVENTION

The disclosure includes a wallet comprising a first personal card receiving area defining a first side wall, a second side wall located a first distance from the first side wall, and a first bottom side wall extending between the first side wall and the second side wall, and a second personal card receiving area defining a third side wall, a fourth side wall located a second distance from the third side wall, and a second bottom side wall extending between the third side wall and the fourth side wall. In some embodiments, the first personal card receiving area is located opposite the second personal card receiving area, the first side wall is located opposite the fourth side wall, the second side wall is located opposite the third side wall, and the first bottom side wall is located opposite the second bottom side wall.

The first personal card receiving area may be configured to receive and retain at least one personal card with respect to the first side wall, the second side wall, and the first bottom side wall, and the second personal card receiving area may be configured to receive and retain at least one personal card with respect to the third side wall, the fourth side wall, and the second bottom side wall. In some embodiments, the first distance defines a length of the first bottom side wall, and wherein the second distance defines a length of the second bottom side wall.

The wallet may include a first protruding portion coupled to the first side wall and configured to move away from the second side wall to thereby receive the at least one personal card. In some embodiments, the first side wall defines a first top portion and a first bottom portion located adjacent the first bottom side wall, wherein the first protruding portion is located adjacent the first top portion. The wallet may also include a second protruding portion coupled to the second side wall and configured to move away from the first side wall to thereby receive the at least one personal card. In some embodiments, the second side wall defines a second top portion and a second bottom portion located adjacent the first bottom side wall, wherein the second protruding portion is located adjacent the second top portion.

The first protruding portion and the second protruding portion may be configured to move between a locked position and a receiving position. In some embodiments, when the first protruding portion and the second protruding portion are in the locked position, the first protruding portion and the second protruding portion are located a first distance from each other. When the first protruding portion and second protruding portion are in the receiving position, the first protruding portion and the second protruding portion may be located a second distance from each other. The first distance may be less than the second distance.

In some embodiments, the wallet further comprises a third protruding portion coupled to the third side wall and configured to move away from the fourth side wall to thereby receive the at least one personal card. The third side wall may define a third top portion and a third bottom portion located adjacent the second bottom side wall, and the third protruding portion may be located adjacent the third top portion. In some embodiments, the wallet includes a fourth protruding portion coupled to the fourth side wall and configured to move away from the third side wall to thereby receive the at least one personal card. The fourth side wall may define a fourth top portion and a fourth bottom portion located adjacent the second bottom side wall, and the fourth protruding portion may be located adjacent the fourth top portion.

The third protruding portion and the fourth protruding portion may be configured to move between a locked position and a receiving position. In some embodiments, when the third protruding portion and the fourth protruding portion are in the locked position, the third protruding portion and the fourth protruding portion are located a first distance from each other. When the third protruding portion and the fourth protruding portion are in the receiving position, the third protruding portion and the fourth protruding portion may be located a second distance from each other. In some embodiments, the first distance is less than the second distance.

The wallet may also include at least one aperture located along a perimeter of the wallet, wherein the at least one aperture may be configured to receive at least one attaching mechanism. In some embodiments, the at least one attaching mechanism comprises at least one of a keyring, a clip, and a tether.

The wallet may further comprise a stretchable band configured to surround at least a portion of the first personal card receiving area and the second personal card receiving area. In some embodiments, the first side wall, the second side wall, the third side wall, and the fourth side wall are elongate along a first direction, and the first bottom side wall and the second bottom side wall are elongate along a second direction perpendicular to the first direction. The stretchable band may be configured to wrap around at least the portion of the first personal card receiving area and the second personal card receiving area along the second direction. In some embodiments, the stretchable band is configured to couple at least one of at least one personal card and at least one paper bill between the stretchable band and at least one of the first personal card receiving area and the second personal card receiving area.

The disclosure includes a carrying device comprising a carabiner including a first clip and a second clip, wherein the first clip is configured to open to access a first chamber and the second clip is configured to open to access a second chamber located adjacent the first chamber, and a shackle defining a first end and a second end located opposite the first end, wherein the first end is configured to detachably couple to the carabiner, and the second end is configured to receive at least one key. In some embodiments, the carabiner comprises a first end including a first aperture and a second end including a second aperture, wherein the first aperture is configured to couple to an attaching mechanism and the second aperture is configured to couple to the first end of the shackle via a first screw.

The first end of the shackle may define a front side, a back side located opposite the front side, and a channel extending between the front side and the back side. In some embodiments, the channel is configured to receive the second aperture of the carabiner. When the channel receives the second aperture, the first screw may be configured to extend through the front side of the shackle, the second aperture of the carabiner, and the back side of the shackle. In some embodiments, the second aperture and the shackle each extend along a first direction. The first screw may be configured to extend through the shackle and the second aperture along a second direction perpendicular to the first direction.

In some embodiments, the carrying device further comprises a second screw configured to couple to the second end of the shackle, wherein the second end of the shackle defines a first arm comprising a first hole and a second arm comprising a second hole. The second screw may be configured to extend through the first hole, through at least one key, and through the second hole, thereby coupling the at least one key to the second end of the shackle. In some embodiments, the second aperture extends along a first direction and the first screw extends along a second direction perpendicular to the first direction. The first arm and the second arm may each extend along a third direction perpendicular to the first direction and the second direction, and the second screw may extend through the first arm and the second arm along the first direction.

In some embodiments, the first screw comprises a first thumb screw and the second screw comprises a second thumb screw. In some embodiments, the carabiner further comprises a third aperture located adjacent the first aperture and a fourth aperture located adjacent the second aperture, wherein the third aperture and the fourth aperture are each configured to receive at least one attaching mechanism.

The first chamber may be located adjacent the first end of the carabiner, and the second chamber may be located adjacent the second end of the carabiner. In some embodiments, each of the first chamber and the second chamber is configured to receive at least one attaching mechanism. The at least one attaching mechanism may comprise at least one of a keyring, a lanyard, a belt loop, a tether, a chain, and a strap.

In some embodiments, the first clip is configured to separate the first chamber from an outside environment and the second clip is configured to separate the first chamber from the second chamber. The first chamber may be larger than the second chamber. In some embodiments, the carrying device further comprises a plurality of ridges extending along an edge of the carabiner adjacent the first chamber and the second chamber.

The carabiner may define a first side wall and a second side wall located opposite the first side wall. In some embodiments, the first clip is located along the first side wall and the second clip is located along the second side wall. The carrying device may further comprise a divider fixedly coupled to the first side wall and the second side wall, and the divider may be configured to separate the first chamber from the second chamber. In some embodiments, the shackle is configured to detachably couple to the carabiner at one of a first location located along the first side wall and a second location located along a third side wall extending between the first side wall and the second side wall. The carabiner and shackle may each comprise at least one material selected from the group consisting of aluminum, titanium, stainless steel, and combinations thereof.

The disclosure includes a wallet comprising an open-sided shell having a front side and a back side facing opposite the front side, the open-sided shell further comprising a first side wall, a second side wall located opposite the first side wall, and a bottom side wall extending between the first side wall and the second side wall. The wallet may also include a plate configured to couple to the open-sided shell along the first side wall, the second side wall, and the bottom side wall, wherein when the plate is coupled to the open-sided shell the wallet may comprise a personal card receiving area extending from the front side to an interior surface of the plate. In some embodiments, the personal card receiving area is configured to receive and retain at least one personal card. The wallet may further comprise a holster configured to couple to the plate along an exterior surface located opposite the interior surface, wherein the holster may be offset from the plate such that the wallet defines a multi-tool receiving area located between the exterior surface of the plate and an interior surface of the holster. In some embodiments, the wallet includes a multi-tool configured to couple to the multi-tool receiving area.

The wallet may further comprise a first protruding portion coupled to the first side wall and configured to move away from the second side wall to thereby receive the at least one personal card. In some embodiments, the first side wall defines a first top portion and a first bottom portion located adjacent the bottom side wall, and the first protruding portion is located adjacent the first top portion. The wallet may include a second protruding portion coupled to the second side wall and configured to move away from the first side wall to thereby receive the at least one personal card. In some embodiments, the second side wall defines a second top portion and a second bottom portion located adjacent the bottom side wall, and the second protruding portion is located adjacent the second top portion.

The bottom side wall may comprise a first bottom side wall portion and a second bottom side wall portion. In some embodiments, the wallet further comprises an open clearance area located between the first bottom side wall portion and the second bottom side wall portion, the open clearance area configured to receive a user’s finger to thereby push the at least one personal card away from the bottom side wall such that the at least one personal card may be removed from the wallet.

In some embodiments, the multi-tool comprises at least one of a bottle opener, a hammer head, a rope tensioner, a serrated edge, a sharp edge, and at least one hex wrench. The exterior surface of the plate may comprise at least one raised portion and the multi-tool may comprise at least one hole sized and configured to receive the at least one raised portion, thereby coupling the multi-tool against the exterior surface of the plate.

The wallet may include a first aperture located on a central portion of the plate, a second aperture located on a central portion of the multi-tool, and a third aperture located on a central portion of the holster. In some embodiments, the first aperture, the second aperture, and the third aperture are configured to align such that a user is able to at least one of view and contact the at least one personal card located in the personal card receiving area. The wallet may also include at least one aperture located along a perimeter of the open-sided shell, the at least one aperture configured to couple to at least one attaching mechanism. In some embodiments, the at least one attaching mechanism comprises at least one of a keyring, a tether, and a clip.

In some embodiments, the wallet further comprises an exterior pocket configured to detachably couple to the back side of the open-sided shell, wherein the exterior pocket is located opposite the holster, and wherein the exterior pocket is configured to receive and retain the at least one personal card. The wallet may include a pull tab coupled to the exterior pocket and configured to extend from an opening in the exterior pocket, and the pull tab may be configured to facilitate removal of the at least one personal card from the exterior pocket.

In some embodiments, the pull tab defines a first portion and a second portion, and the pull tab is configured to move between a first position and a second position. In the first position, the first portion of the pull tab may be configured to extend from the opening in the exterior pocket and the second portion of the pull tab may be located at least partially within the exterior pocket, and the at least one personal card may be located within the exterior pocket. In some embodiments, in the second position, the first portion of the pull tab and the second portion of the pull tab are configured to extend from the opening in the exterior pocket, and the at least one personal card is configured to at least partially extend from the exterior pocket.

The back side of the open-sided shell may comprise a channel and the exterior pocket may comprise a back plate configured to slideably couple to the channel, thereby coupling the exterior pocket to the open-sided shell.

In some embodiments, the wallet includes a flexible member defining a top half and a bottom half, wherein the bottom half is configured to detachably couple to the back side of the open-sided shell, and wherein the top half is configured to at least partially cover the front side of the open-sided shell, the multi-tool, and the holster, the flexible member further comprising an interior surface and an exterior surface located opposite the interior surface. The wallet may include a first exterior pocket located on the top half of the flexible member along the exterior surface, a second exterior pocket located on the bottom half of the flexible member along the exterior surface, the second exterior pocket located opposite the open-sided shell, an interior pocket located on the top half of the flexible member along the interior surface, the interior pocket located opposite the first exterior pocket, and a middle pocket located on the top half of the flexible member between the first exterior pocket and the interior pocket.

In some embodiments, the wallet also includes a pull tab coupled to the second exterior pocket and configured to extend from an opening in the second exterior pocket, the pull tab configured to facilitate removal of the at least one personal card from the second exterior pocket. The pull tab may define a first portion and a second portion, and the pull tab may be configured to move between a first position and a second position. In some embodiments, in the first position, the first portion of the pull tab is configured to extend from the opening in the second exterior pocket and the second portion of the pull tab is located at least partially within the second exterior pocket, and the at least one personal card is located within the second exterior pocket. In the second position, the first portion of the pull tab and the second portion of the pull tab may be configured to extend from the opening in the second exterior pocket, and the at least one personal card may be configured to at least partially extend from the second exterior pocket.

The multi-tool may comprise a first multi-tool, and the wallet may further comprise a second multi-tool coupled to a first end of a strap, wherein a second end of the strap is configured to couple to the bottom half of the flexible member. In some embodiments, the wallet includes a clasp pocket coupled to the top half of the flexible member along the exterior surface, wherein the clasp pocket is configured to receive at least a portion of the second multi-tool, thereby securing the flexible member in a closed position.

The interior pocket may define an identification window, and the identification window may include an aperture configured to allow a user to at least one of view and contact the at least one personal card located in the identification window. In some embodiments, the wallet includes a card coupled to an expandable loop, wherein the interior pocket is configured to receive the card and the expandable loop is configured to extend from a side portion of the flexible member, the expandable loop configured to receive and retain a pen. The back side of the open-sided shell may comprise a channel and the second exterior pocket may comprise a back plate configured to slideably couple to the channel, thereby coupling the second exterior pocket to the open-sided shell.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a perspective view of a wallet including a first personal card receiving area, according to some embodiments.

FIG. 2 illustrates a perspective view of a wallet including a second personal card receiving area, according to some embodiments.

FIG. 3 illustrates a front view of a wallet, according to some embodiments.

FIG. 4 illustrates a back view of a wallet, according to some embodiments.

FIG. 5 illustrates a front view of a wallet including a stretchable band, according to some embodiments.

FIG. 6 illustrates a back view of a wallet including a stretchable band, according to some embodiments.

FIG. 7 illustrates a perspective view of a carrying device including a carabiner and a shackle, according to some embodiments.

FIG. 8 illustrates a perspective view of a carabiner, according to some embodiments.

FIG. 9 illustrates a front view of a carrying device including a carabiner and a shackle, according to some embodiments.

FIG. 10 illustrates a front perspective view of a wallet, according to some embodiments.

FIG. 11 illustrates a back perspective view of a wallet, according to some embodiments.

FIG. 12 illustrates a front view of a wallet, according to some embodiments.

FIG. 13 illustrates a back view of a wallet, according to some embodiments.

FIG. 14 illustrates an exterior perspective view of a bifold wallet in an open position, according to some embodiments.

FIG. 15 illustrates an interior perspective view of a bifold wallet in an open position, according to some embodiments.

FIG. 16 illustrates a perspective view of a carrying device including a carabiner and a shackle, according to some embodiments.

FIG. 17 illustrates a front view of a carabiner, according to some embodiments.

FIG. 18 illustrates a perspective view of a carrying device including a carabiner and a shackle, according to some embodiments.

FIGS. 19 and 20 illustrate front views of a carabiner, according to some embodiments.

FIG. 21 illustrates a front view of a shackle coupled to at least one key, according to some embodiments.

FIG. 22 illustrates a side view of a shackle, according to some embodiments.

FIG. 23 illustrates a perspective view of a carabiner coupled to a plurality of attaching mechanisms, according to some embodiments.

### COMPONENT INDEX

100 – wallet

102 – first personal card receiving area

104a – first side wall

104b – second side wall

104c – first bottom side wall

200 – second personal card receiving area

202a – third side wall

202b – fourth side wall

202c – second bottom side wall

300a – first protruding portion

300b – second protruding portion

400a – third protruding portion

400b – fourth protruding portion

500 – at least one aperture

502 – stretchable band

700 – carrying device

702 – carabiner

704 – shackle

800a – first end (of carabiner)

800b – second end (of carabiner)

802a – first clip

802b – second clip

804a – first chamber

804b – second chamber

806 – first aperture

808 – second aperture

900a – first end (of shackle)

900b – second end (of shackle)

902 – first screw

904 – second screw

906 – third aperture

908 – fourth aperture

1000 – wallet

1002 – open-sided shell

1004 – exterior pocket

1006 – pull tab

1100 – plate

1102 – holster

1104 – multi-tool

1106 – personal card receiving area

1300a – first protruding portion

1300b – second protruding portion

1302 – at least one aperture

1400 – flexible member

1402 – top half

1404 – bottom half

1406 – exterior surface

1408 – first exterior pocket

1410 – second exterior pocket

1412 – clasp pocket

1500 – interior pocket

1502 – middle pocket

1504 – interior surface

1506 – second multi-tool

1508 – strap

1510 – identification window

1600 – carrying device

1602 – carabiner

1604 – shackle

1606 – plurality of ridges

1700a – first end (of carabiner)

1700b – second end (of carabiner)

1702a – first clip

1702b – second clip

1704a – first chamber

1704b – second chamber

1706 – first aperture

1708 – second aperture

1710 – third aperture

1712 – bottle opener

1800 – carrying device

1802 – carabiner

1804 – shackle

1806a – first side wall

1806b – second side wall

1806c – third side wall

1808 – divider

1900a – first end (of carabiner)

1900b – second end (of carabiner)

1902a – first clip

1902b – second clip

1904a – first chamber

1904b – second chamber

1906 – first location

1908 – second location

2000 – first aperture

2002 – opening

2004 – second aperture

2006 – third aperture

2008 – fourth aperture

2010 – fifth aperture

2012 – sixth aperture

2014 – seventh aperture

2100 – at least one key

2102a – first arm

2102b – second arm

2200 – front side

2202 – back side

2204 – channel

2206a – first hole (of first arm)

2206b – second hole (of second arm)

2300a – attaching mechanism

2300b – attaching mechanism

2300c – attaching mechanism

2300d – attaching mechanism

2300e – attaching mechanism

2302 – outside environment

### DETAILED DESCRIPTION OF THE INVENTION

Everyday carry devices, such as wallets, multi-tools, keyrings, phones, and the like, are, as the name implies, items meant to be carried and utilized by a user every day. These devices help users organize their most commonly used items, including credit cards, keys, and tools, among others. This disclosure includes multiple everyday carry devices.

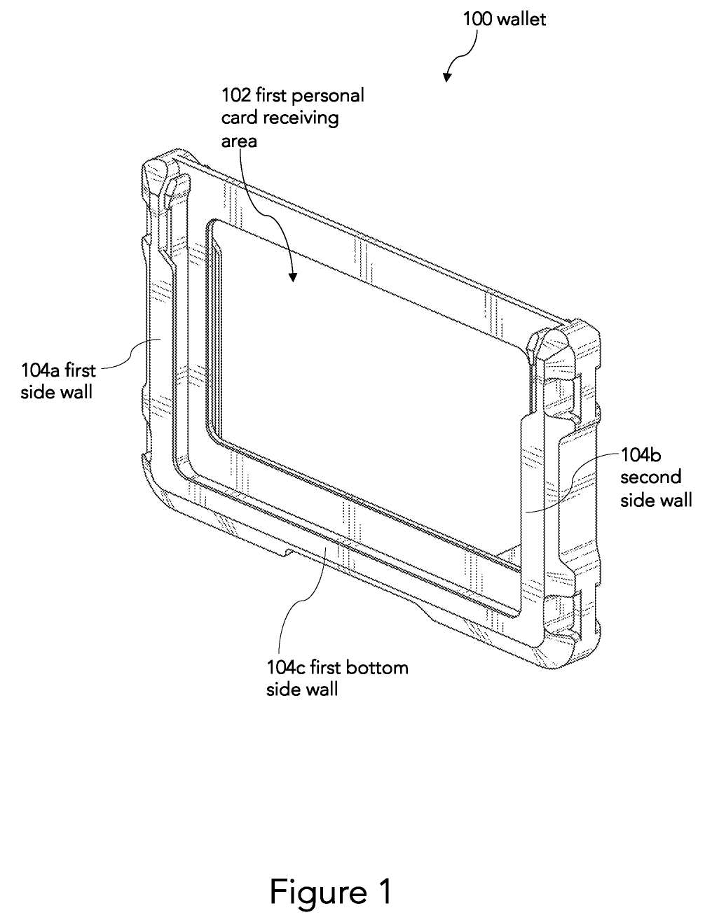

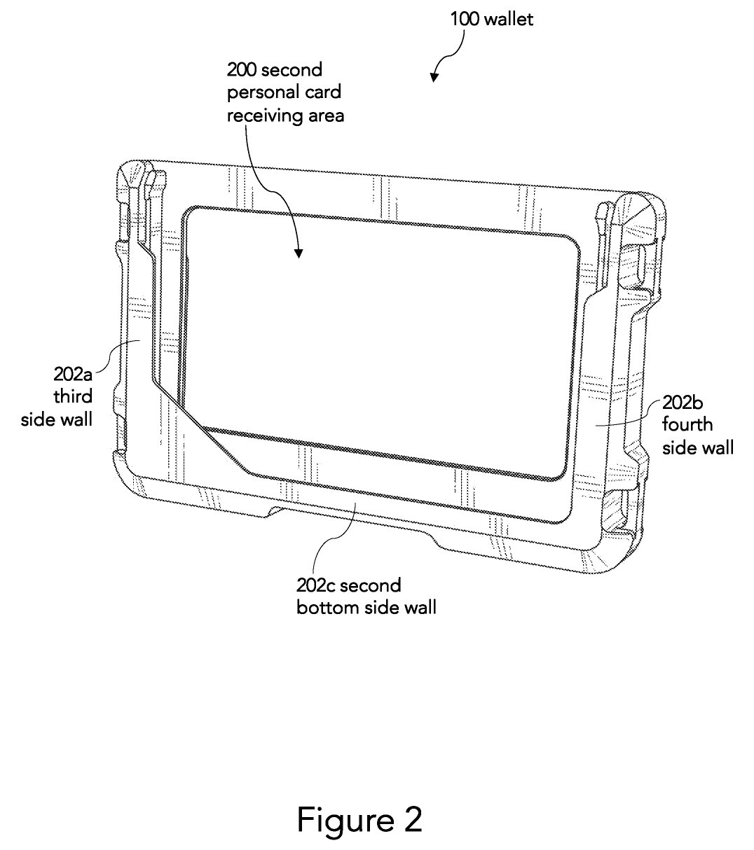

FIG. 1 illustrates a wallet 100 including a first personal card receiving area 102. In some embodiments, as shown in FIG. 1, the first personal card receiving area 102 is bordered on three sides by a first side wall 104a, a second side wall 104b, and a first bottom side wall 104c. The wallet 100 may also include a second personal card receiving area 200, as shown in FIG. 2. In some embodiments, the second personal card receiving area 200 is located opposite the first personal card receiving area 102. The second personal card receiving area 200 may be bordered on three sides by a third side wall 202a, a fourth side wall 202b, and a second bottom side wall 202c.

In some embodiments, the first side wall 104a is located opposite the fourth side wall 202b, the second side wall 104b is located opposite the third side wall 202a, and the first bottom side wall 104c is located opposite the second bottom side wall 202c. Each of the first personal card receiving area 102 and the second personal card receiving area 200 may be configured to receive and retain at least one personal card, such as a credit card, identification card, library card, insurance card, business card, gift card, or the like. In some embodiments, each of the first personal card receiving area 102 and the second personal card receiving area 200 is configured to hold about five personal cards, depending on the thickness of each card.

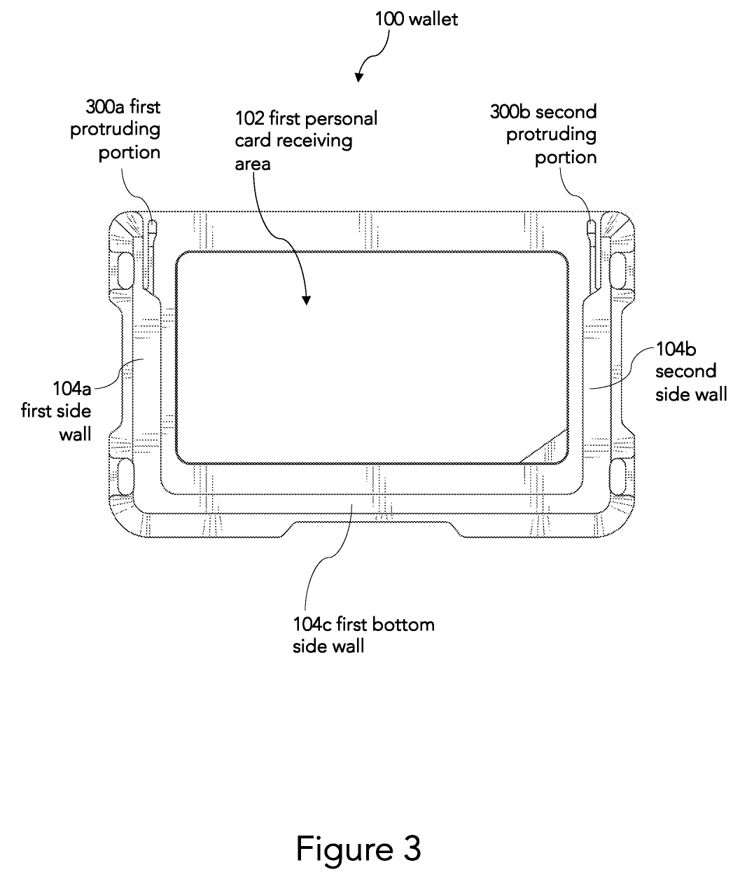

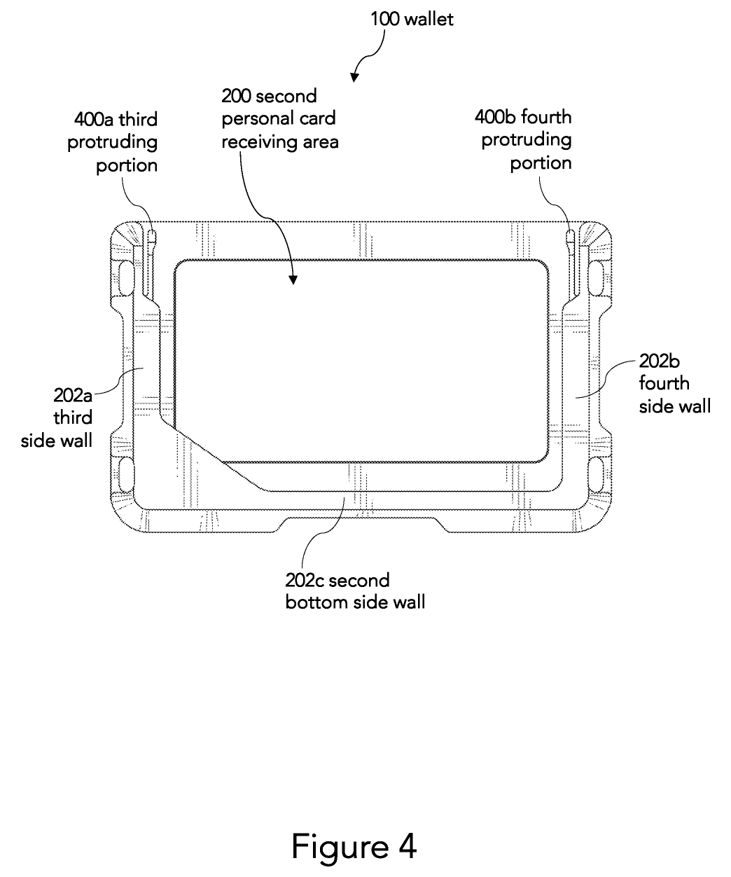

FIG. 3 illustrates a front view of the wallet 100 and the first personal card receiving area 102. In some embodiments, the wallet 100 includes a first protruding portion 300a coupled to the first side wall 104a and a second protruding portion 300b coupled to the second side wall 104b. Similarly, as shown in FIG. 4, the wallet 100 may include a third protruding portion 400a coupled to the third side wall 202a and a fourth protruding portion 400b coupled to the fourth side wall 202b. Each of the first protruding portion 300a, the second protruding portion 300b, the third protruding portion 400a, and the fourth protruding portion 400b may be configured to move between a locked position and a receiving position. In some embodiments, in the receiving position, the first protruding portion 300a, the second protruding portion 300b, the third protruding portion 400a, and the fourth protruding portion 400b are configured to flex in order to receive the at least one personal card. In the locked position, the first protruding portion 300a, the second protruding portion 300b, the third protruding portion 400a, and the fourth protruding portion 400b may move back to their original positions in order to retain the at least one personal card within the first or second personal card receiving area 102, 200, as applicable.

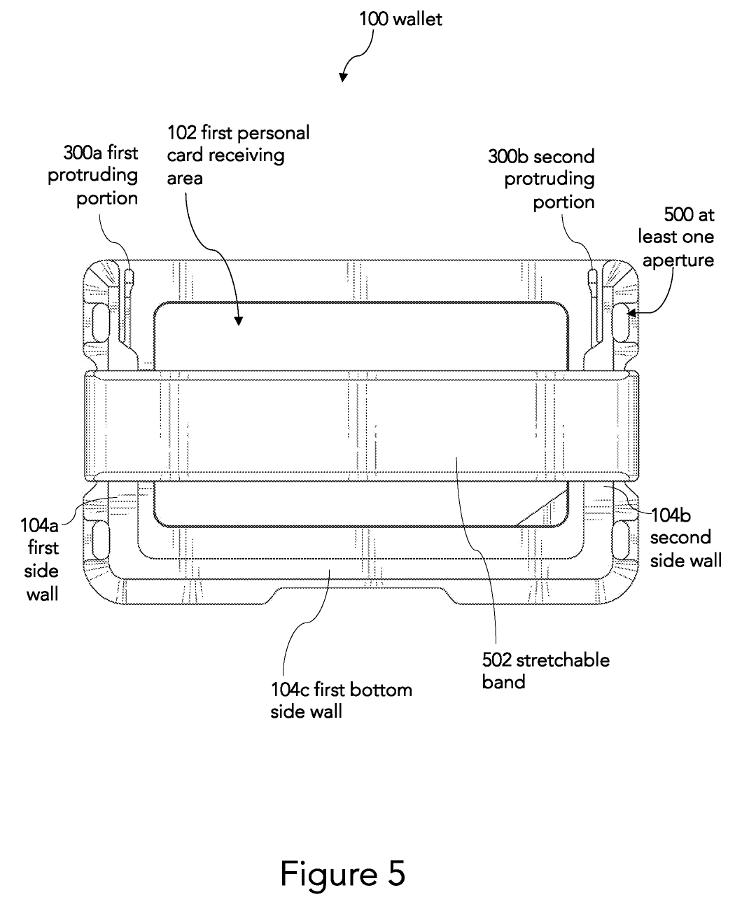

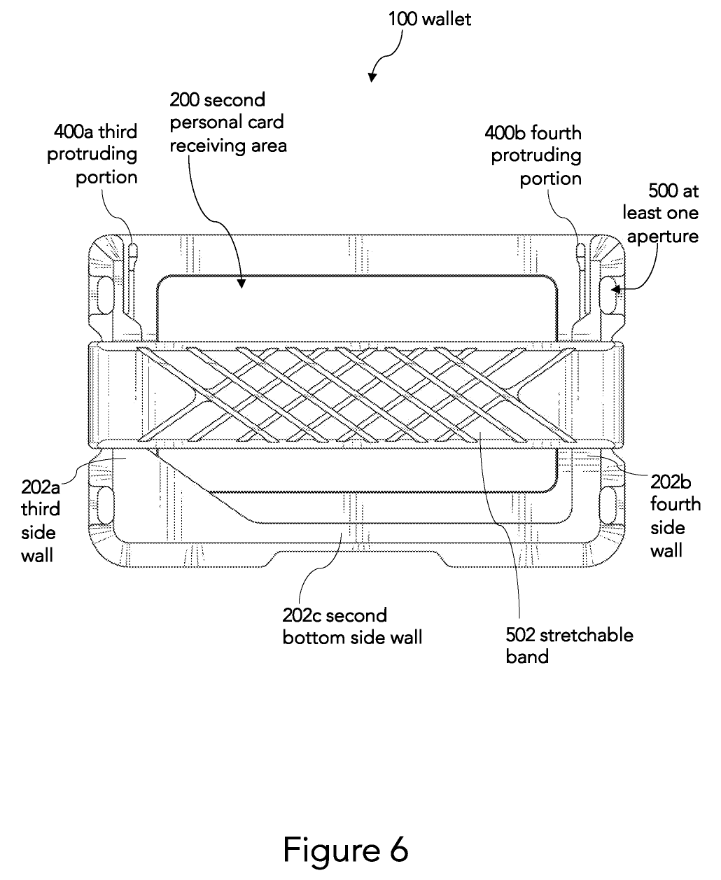

FIG. 5 illustrates that, in some embodiments, the wallet 100 includes at least one aperture 500 located around a perimeter of the wallet 100. For example, as shown in FIGS. 5 and 6, the at least one aperture 500 may include a total of four apertures. The at least one aperture 500 may include less than four apertures. In some embodiments, the at least one aperture 500 includes more than four apertures.

FIGS. 5 and 6 also include a stretchable band 502 wrapped around the wallet 100. In some embodiments, the stretchable band 502 is configured to wrap around the first side wall 104a, the second side wall 104b, the third side wall 202a, and the fourth side wall 202b. The stretchable band 502 may be configured to hold at least one personal card and/or at least one paper bill (e.g., cash) against the first personal card receiving area and the second personal card receiving area 200. The stretchable band 502 may be comprised of silicone, and the rest of the wallet 100 may be comprised of metal.

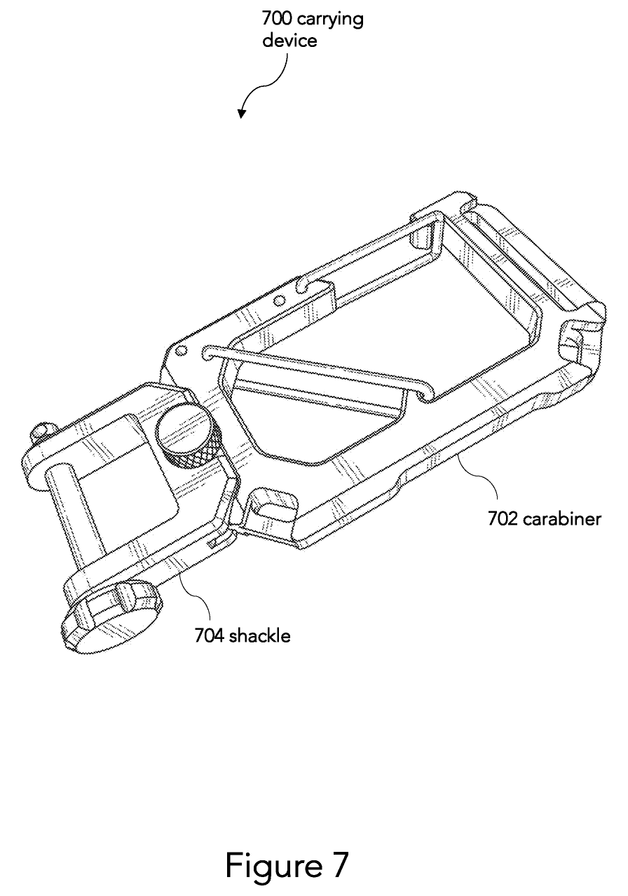

FIG. 7 illustrates a carrying device 700 including a carabiner 702 and a shackle 704. In some embodiments, the shackle 704 is configured to couple to the carabiner 702, as shown in FIG. 7. It should be noted that the carabiner 702 and the shackle 704 may be used independently of one another, or they may be used when attached as one multi-piece unit, as demonstrated in FIG. 7. Each of the carabiner 702 and the shackle 704 may be comprised of metal.

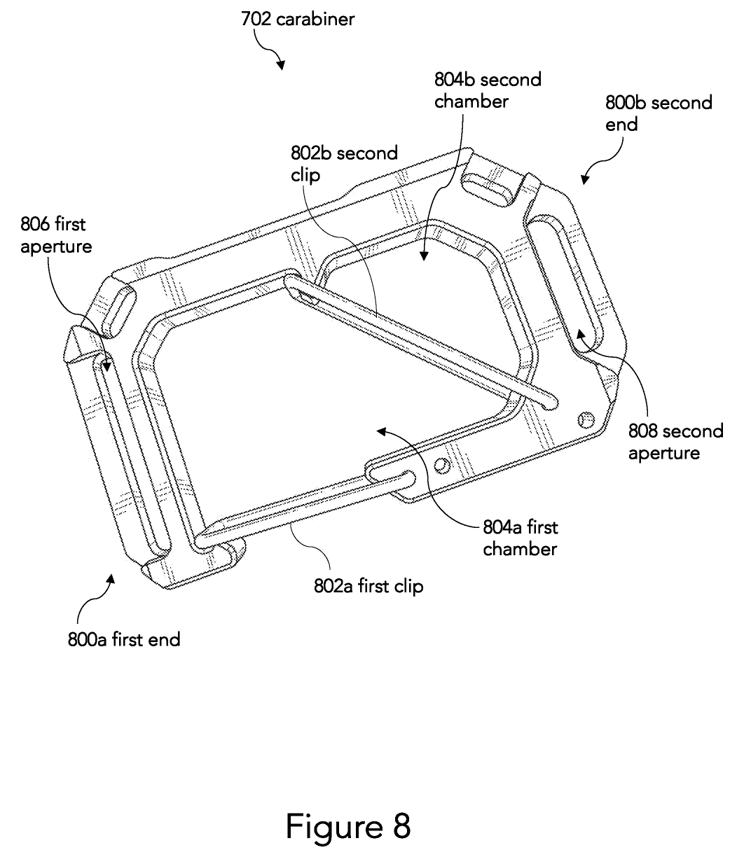

FIG. 8 shows the carabiner 702 in greater detail. In some embodiments, the carabiner 702 includes a first end 800a and a second end 800b located opposite the first end 800a. The carabiner 702 may also include a first clip 802a and a second clip 802b, wherein the first clip 802a may be configured to access a first chamber 804a and the second clip 802b may be configured to access a second chamber 804b. In some embodiments, the carabiner 702 includes a first aperture 806 located at the first end 800a and a second aperture 808 located at the second end 800b. The second aperture 808 may be configured to couple to the shackle 704 to thereby couple the shackle 704 to the carabiner 702.

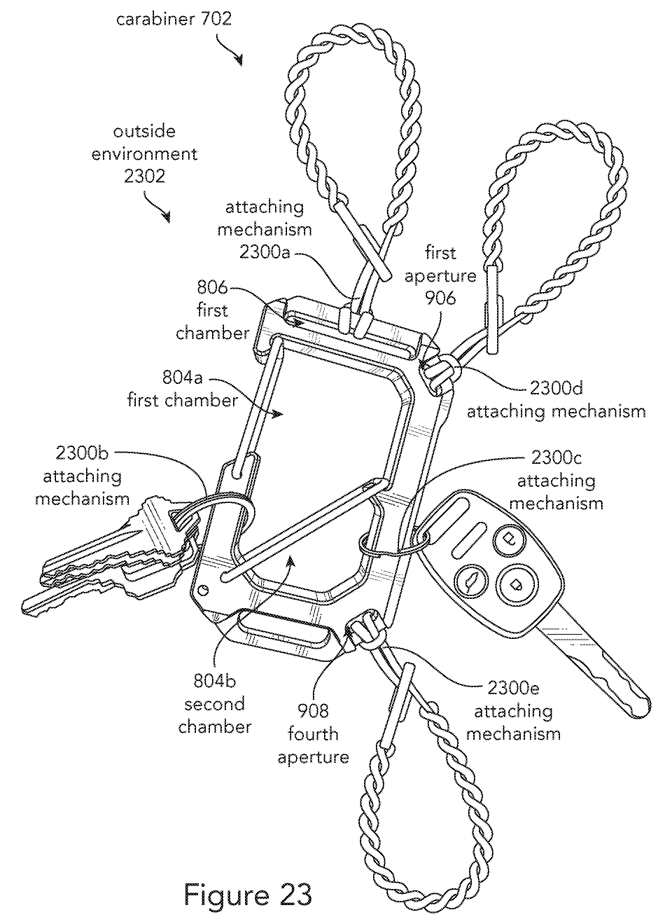

In some embodiments, the carabiner 702 is configured to couple to at least one external element via at least one of the first chamber 804a and the second chamber 804b. For example, the first clip 802a may be configured to open to receive an attaching mechanism into the first chamber 804a. The attaching mechanism may comprise a belt loop, a strap of a bag, a tether, a lanyard, a keychain, or the like. Likewise, the second clip 802b may be configured to open to receive an attaching mechanism into the second chamber 804b. The first aperture 806 may also be configured to receive an attaching mechanism. FIG. 23 shows the carabiner 702 coupled to a plurality of attaching mechanisms.

In some embodiments, the inclusion of two separate chambers allows a user of the carrying device 700 to separate attaching mechanisms. For example, a keyring holding the user’s house, apartment, or car keys may be securely coupled to the carabiner 702 via the second chamber 804b, while the carabiner 702 is coupled to the user’s belt or bag via the first chamber 804a. Because the keyring is separated from the first chamber 804a by the second clip 802b, the user may be assured that the first clip 802a can be repeatedly opened and closed (e.g., to remove and reattach the carabiner 702 to the belt or bag) without the risk that the keyring will accidentally detach from the carabiner 702. The first chamber 804a and the second chamber 804b may be substantially the same size. In some embodiments, the first chamber 804a is larger than the second chamber 804b. The first chamber 804a may be smaller than the second chamber 804b.

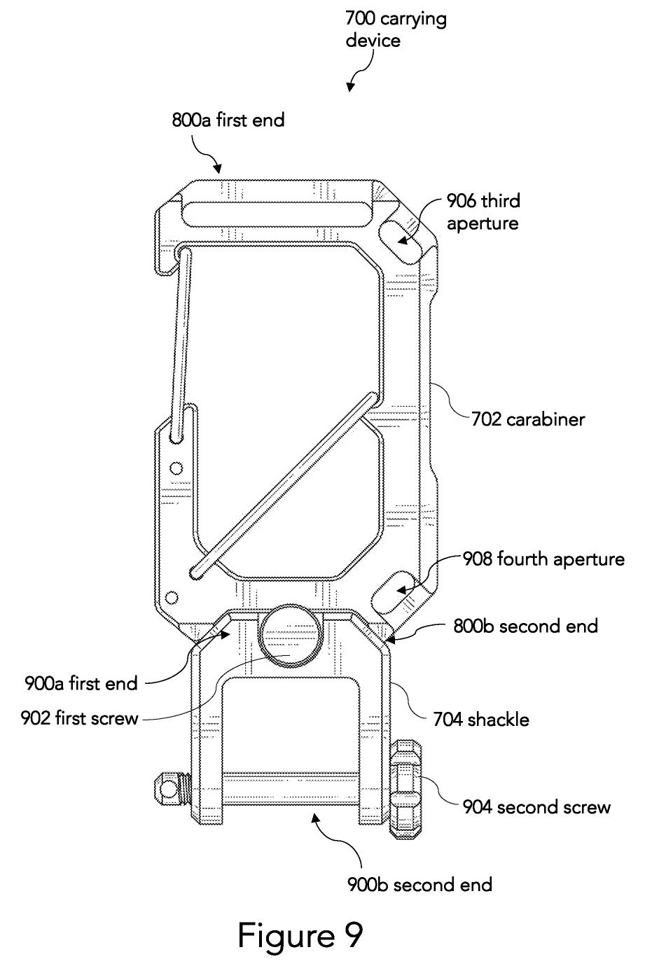

FIG. 9 includes additional details of the carrying device 700. As previously mentioned, the shackle 704 may be configured to couple to the second end 800b of the carabiner 702. In some embodiments, in addition to the first aperture 806 and second aperture 808 shown in FIG. 8, the carabiner 702 includes a third aperture 906 and a fourth aperture 908. Each of the third aperture 906 and the fourth aperture 908 may be configured to couple to an attaching mechanism such as a keyring, a lanyard, a clip, a tether, or the like. FIG. 23 shows the third aperture 906 and the fourth aperture 908 each coupled to an attaching mechanism.

In some embodiments, as shown in FIG. 9, the shackle 704 comprises a first end 900a and a second end 900b located opposite the first end 900a. The shackle 704 may also include a first screw 902 and a second screw 904. In some embodiments, the first screw 902 is configured to couple the first end 900a of the shackle 704 to the second end 800b of the carabiner 702. The second screw 904 may be configured to detachably couple from the second end 900b in order to receive at least one key. For example, the second screw 904 may be configured to thread through at least one key/keyring and couple back to the second end 900b of the shackle 704, thereby coupling the at least one key/keyring to the shackle 704. The second screw 904 may include an opening for a pin or similar mechanism to ensure secure coupling to the shackle 704. In some embodiments, the first screw 902 and the second screw 904 comprise thumb screws configured to threadably couple to the shackle 704.

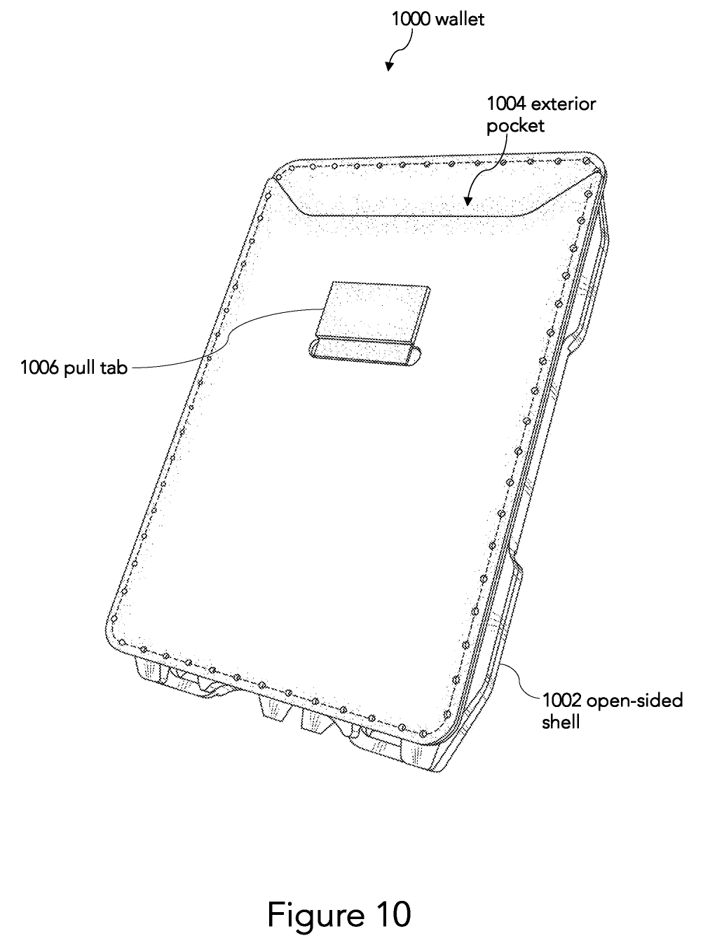

FIG. 10 illustrates a front perspective view of a wallet 1000 including an open-sided shell 1002 and an exterior pocket 1004. In some embodiments, the wallet 1000 further comprises a pull tab 1006 coupled to the exterior pocket 1004, wherein the pull tab 1006 is configured to facilitate at least partial removal of a personal card and/or paper bill located in the exterior pocket 1004.

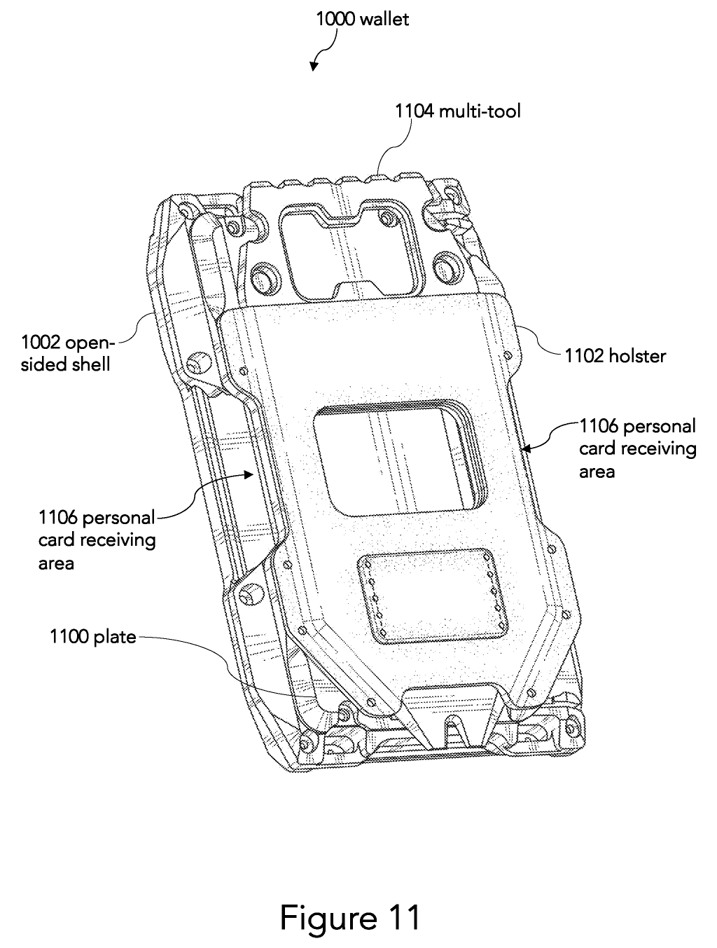

FIG. 11 illustrates a back perspective view of the wallet 1000. In some embodiments, the wallet 1000 includes a plate 1100 coupled to the open-sided shell 1002, and a holster 1102 coupled to the plate 1100. The wallet 1000 may comprise a personal card receiving area 1106 located between the open-sided shell 1002 and the plate 1100. In some embodiments, the personal card receiving area 1106 is configured to receive at least one personal card, such as a credit card, identification card, library card, insurance card, business card, gift card, or the like. The wallet 1000 may be configured to couple to a multi-tool 1104. In some embodiments, the multi-tool 1104 is configured to couple between the holster 1102 and the plate 1100. The multi-tool 1104 may define several functions, including, but not limited to, bottle opener, strap cutter, wrench, screwdriver, nail pryer, chisel, rope tensioner, sharp edge, serrated edge, hammer head, etc.

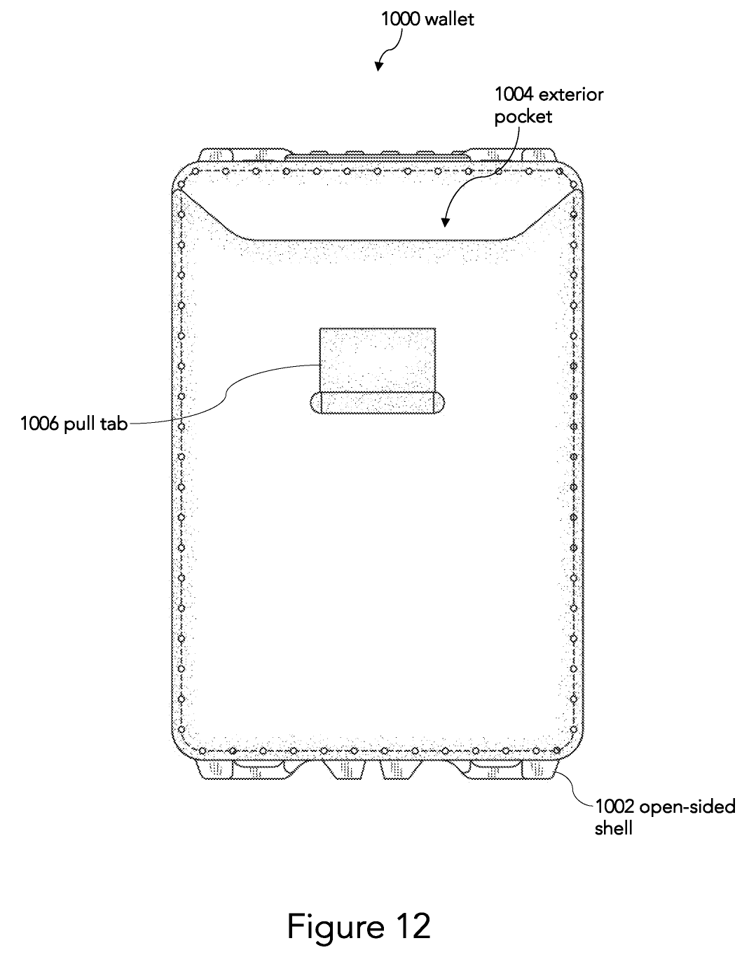

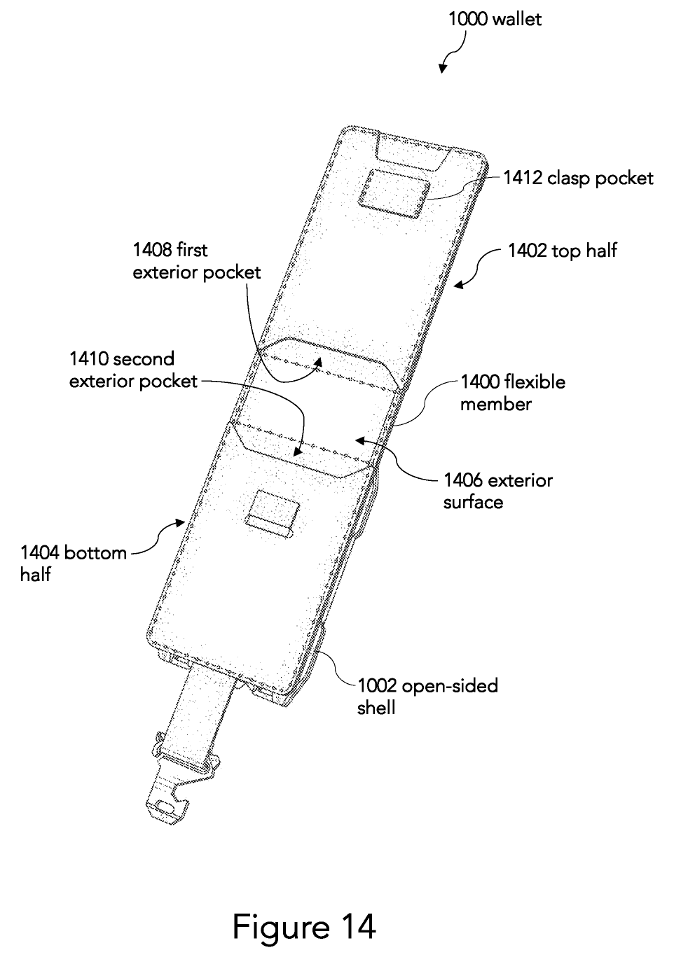

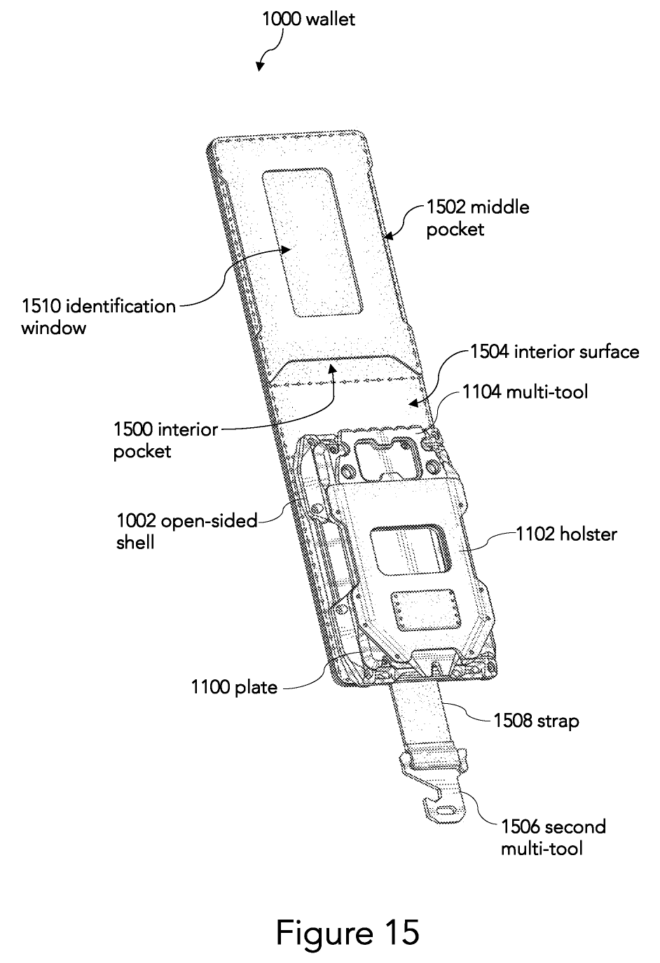

FIG. 12 shows a front view of the wallet 1000, including a portion of the open-sided shell 1002 and the exterior pocket 1004, including the pull tab 1006. In some embodiments, the exterior pocket 1004 is removably coupled to the open-sided shell 1002. The open-sided shell 1002 may be configured to couple to a number of other accessories, such as a bifold (see FIGS. 14 and 15), a notebook, or any other type of cover. The exterior pocket 1004 may comprise a soft material, such as leather or DTEX.

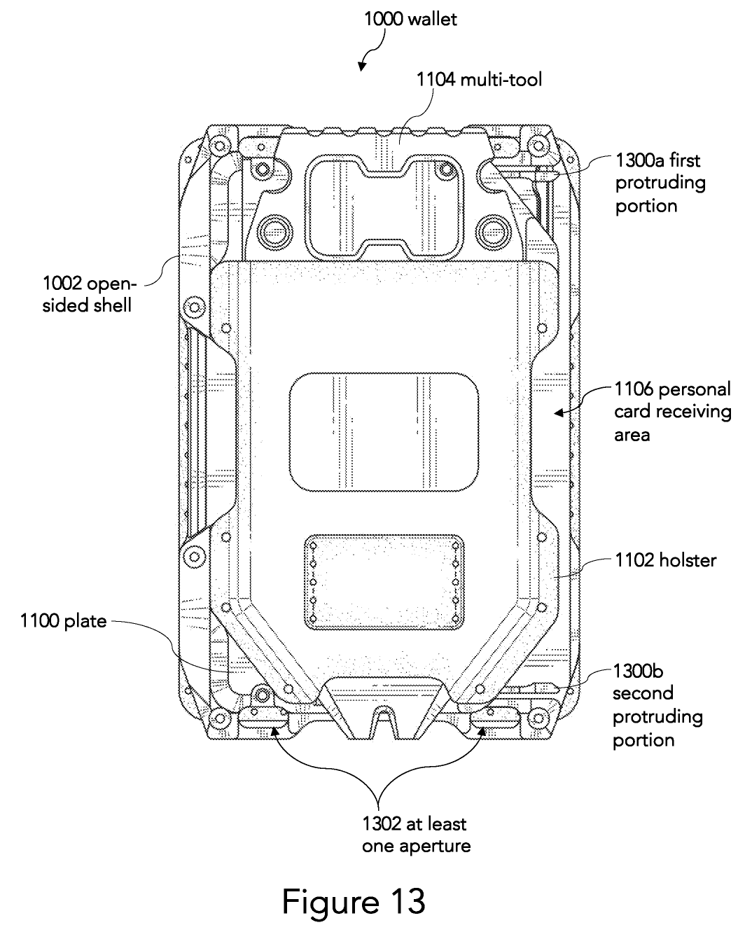

FIG. 13 illustrates a back view of the wallet 1000. In some embodiments, as shown in FIG. 13, the wallet 1000 includes a first protruding portion 1300a and a second protruding portion 1300b coupled to the open-sided shell 1002. Each of the first protruding portion 1300a and the second protruding portion 1300b may be configured to move between a locked position and a receiving position. In some embodiments, in the receiving position, the first protruding portion 1300a and the second protruding portion 1300b are configured to flex in order to receive the at least one personal card into the personal card receiving area 1106. In the locked position, the first protruding portion 1300a and the second protruding portion 1300b may move back to their original positions in order to retain the at least one personal card within the personal card receiving area 1106.

The wallet 1000 may also include at least one aperture 1302. In some embodiments, the at least one aperture 1302 is configured to receive at least one attaching mechanism, such as a keyring, tether, lanyard, strap, clip, or the like. As shown in FIG. 13, the at least one aperture 1302 may comprise two apertures. The at least one aperture 1302 may comprise more than two apertures. In some embodiments, the at least one aperture 1302 comprises fewer than two apertures.

The plate 1100 may include at least one circular protrusion, or “nub,” configured to be received by at least one opening in the multi-tool 1104. In some embodiments, coupling between the nub and the opening helps hold the multi-tool 1104 in place with respect to the holster 1102 and the plate 1100. The multi-tool 1104 may be partially removed, e.g., by disengaging the at least one nub from the at least one opening. For example, if a user wants to use the bottle opener of the multi-tool 1104 without completely removing the multi-tool 1104 from the wallet 1000, the user may disengage the at least one nub from the at least one opening and partially remove the multi-tool 1104 from the holster 1102. The holster 1102 may also be configured to at least partially surround the multi-tool 1104 such that any sharp, serrated, or otherwise abrasive components are safely held within the holster 1102 and not exposed when the wallet 1000 is in use with the multi-tool 1104 stowed.

FIG. 14 illustrates an exterior perspective view of the wallet 1000. Unlike FIGS. 10-13, where the wallet 1000 is coupled to the single exterior pocket 1004, FIG. 14 (as well as FIG. 15) Illustrates the wallet 1000 coupled to a bifold-style flexible member 1400 comprising a top half 1402 and a bottom half 1404. In some embodiments, the bottom half 1404 is coupled to the open-sided shell 1002 and the top half 1402 is configured to fold around to cover the interior surface of the open-sided shell 1002, including the plate 1100, holster 1102, and multi-tool 1104. FIG. 14 shows the exterior surface 1406 of the flexible member 1400, including a first exterior pocket 1408 and a second exterior pocket 1410. In some embodiments, the first exterior pocket 1408 is coupled to the top half 1402 and the second exterior pocket 1410 is coupled to the bottom half 1404. Also shown in FIG. 14 is a clasp pocket 1412.

FIG. 15 shows an interior perspective view of the wallet 1000, including the interior surface 1504 of the flexible member 1400. In some embodiments, the wallet 1000 includes an interior pocket 1500 comprising an identification window 1510. The wallet 1000 may also include a middle pocket 1502 located between the interior pocket 1500 and the first exterior pocket 1408.

In some embodiments, the wallet 1000 includes a strap 1508 extending from the bottom half 1404 of the flexible member 1400. The strap 1508 may be coupled to a second multi-tool 1506. In some embodiments, the second multi-tool 1506 is configured to be received by the clasp pocket 1412 to thereby close the wallet 1000. The second multi-tool 1506 may define a number of functions, including as a screwdriver and wrench, among others.

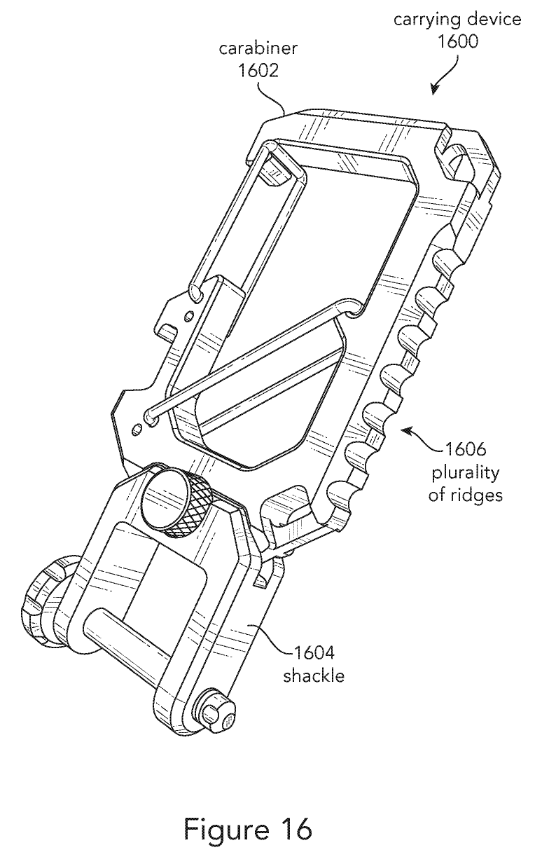

FIG. 16 shows a perspective view of a carrying device 1600 including a carabiner 1602 and a shackle 1604. In some embodiments, the carrying device 1600 is similar to the carrying device 700 shown in FIGS. 7 and 9. The shackle 1604 may be configured to couple to the carabiner 1602, as shown in FIG. 16, so that the carabiner 1602 and the shackle 1604 may be used as one multi-piece unit. In some embodiments, the carabiner 1602 and the shackle 1604 are used independently of one another.

Unlike the carabiner 702 shown in FIGS. 7-9, in some embodiments, the carabiner 1602 includes a plurality of ridges 1606, as shown in FIG. 16. The plurality of ridges 1606 may be configured to enhance a user’s grip on the carabiner 1602. The plurality of ridges 1606 may be thought of as a serrated edge of the carabiner 1602. In some embodiments, the carabiner 1602 includes a plurality of ridges 1606 on multiple edges, or side walls, of the carabiner 1602.

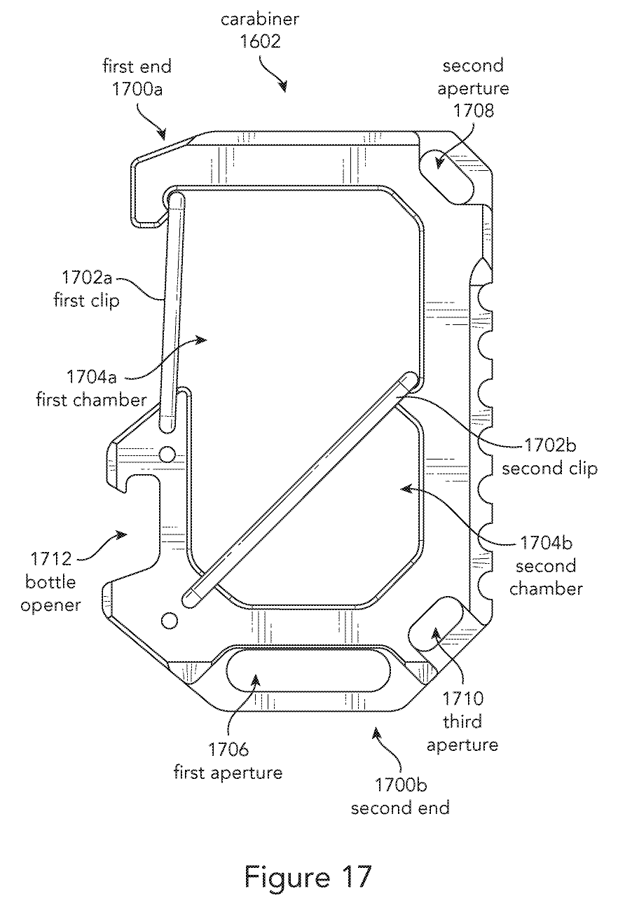

FIG. 17 shows a front view of the carabiner 1602 uncoupled from the shackle 1604. Similar to the carabiner 702, the carabiner 1602 may include a first end 1700a and a second end 1700b located opposite the first end 1700a, as well as a first clip 1702a and a second clip 1702b. In some embodiments, the first clip 1702a is configured to open to access the first chamber 1704a and the second clip 1702b is configured to open to access the second chamber 1704b. As demonstrated in FIG. 17, the first chamber 1704a may be located adjacent the first end 1700a of the carabiner 1602, and the second chamber 1704b may be located adjacent the second end 1700b of the carabiner 1602.

As discussed with reference to FIG. 8, in some embodiments, the carabiner 1602 is configured to couple to at least one external element via at least one of the first chamber 1704a and the second chamber 1704b. For example, the first clip 1702a may be configured to open to receive an attaching mechanism into the first chamber 1704a. The attaching mechanism may comprise a belt loop, a strap of a bag, a tether, a lanyard, a keychain, or the like. Likewise, the second clip 1702b may be configured to open to receive an attaching mechanism into the second chamber 1704b.

In some embodiments, the first clip 1702a, like the first clip 802a of the carabiner 702, is configured to separate the first chamber 1704a (or the first chamber 804a) from the outside environment. The second clip 1702b, like the second clip 802b, may be configured to separate the first chamber 1704a, 804a from the second chamber 1704b, 804b. Stated another way, the first clip 1702a, 802a may be considered an “initial” access point into the carabiner 1602, 702, while the second clip 1702b, 802b provides access from one portion (i.e., the first chamber 1704a, 804a) of the carabiner 1602, 702 into another portion (i.e., the second chamber 1704b, 804b) of the carabiner 1602, 702. The first chamber 1704a and the second chamber 1704b may be substantially the same size. In some embodiments, the first chamber 1704a is larger than the second chamber 1704b. The first chamber 1704a may be smaller than the second chamber 1704b.

In some embodiments, the inclusion of two separate chambers allows a user of the carrying device 1600 to separate attaching mechanisms. For example, a keyring holding the user’s house, apartment, or car keys may be securely coupled to the carabiner 1602 via the second chamber 1704b, while the carabiner 1602 is coupled to the user’s belt or bag via the first chamber 1704a. Because the keyring is separated from the first chamber 1704a by the second clip 1702b, the user may be assured that the first clip 1702a can be repeatedly opened and closed (e.g., to remove and reattach the carabiner 1602 to the belt or bag) without the risk that the keyring will accidentally detach from the carabiner 1602.

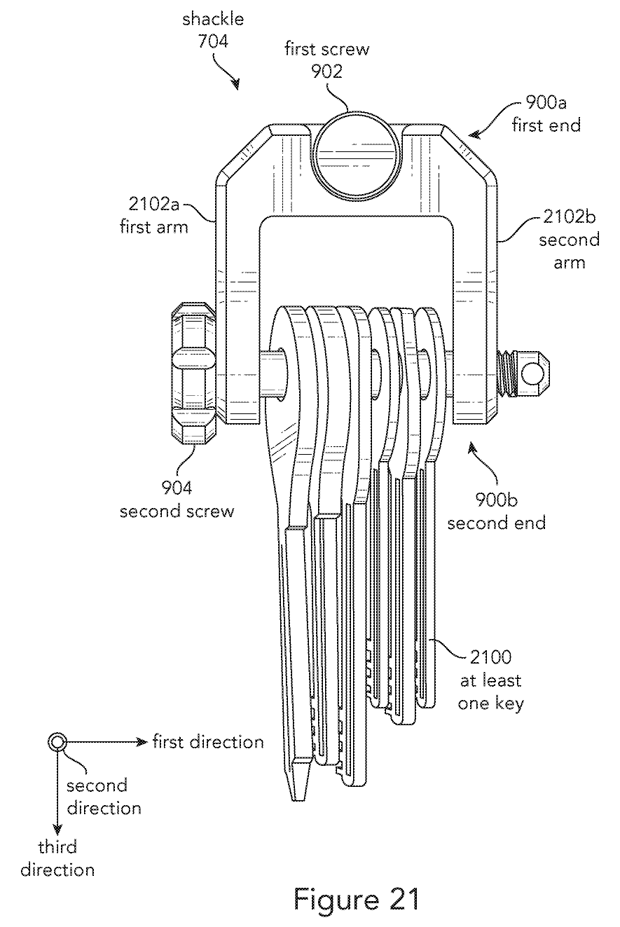

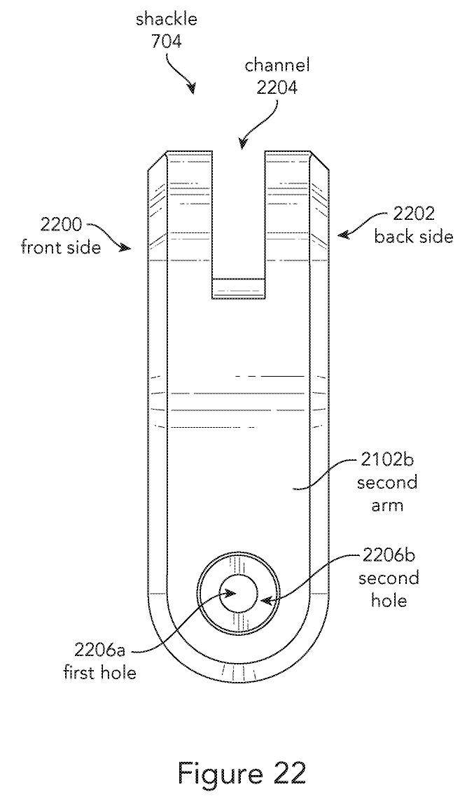

FIG. 17 also illustrates that, in some embodiments, the carabiner 1602 includes a plurality of apertures located around the perimeter of the carabiner 1602. For example, the carabiner 1602 may include a first aperture 1706 located at the second end 1700b, a second aperture 1708 located in a corner along the first end 1700a, and a third aperture 1710 located in a different corner along the second end 1700b. In some embodiments, the first aperture 1706 is configured to couple to the shackle 1604 to thereby couple the shackle 1604 to the second end 1700b of the carabiner 1602, in a manner that will be discussed in greater detail with reference to FIGS. 21 and 22. The second aperture 1708 and the third aperture 1710 may be configured to receive at least one attaching mechanism such as a tether, keyring, a lanyard, a clip, or the like. In some embodiments, the carabiner 1602 includes a bottle opener 1712 located along the perimeter of the carabiner 1602. The bottle opener 1712 may be located along a side edge opposite the plurality of ridges 1606, as shown, or may be located elsewhere along the carabiner 1602, such as along the first end 1700a.

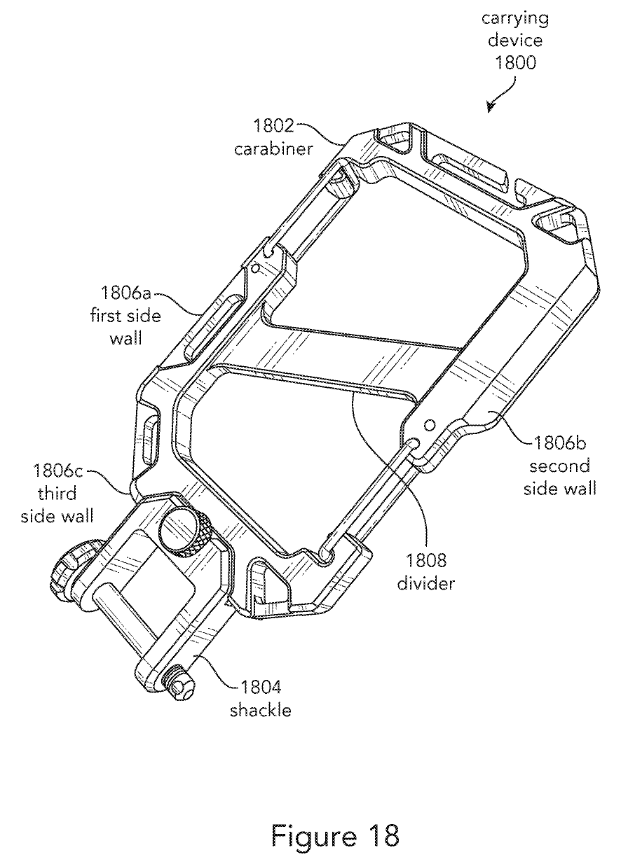

FIG. 18 shows a perspective view of another carrying device 1800. Like the carrying devices 700 and 1600, the carrying device 1800 comprises a carabiner 1802 and a shackle 1804. As illustrated in FIG. 18, the carabiner 1802 may include a first side wall 1806a, a second side wall 1806b, and a third side wall 1806c. In some embodiments, the second side wall 1806b is located opposite the first side wall 1806a, and the third side wall 1806c extends between the first side wall 1806a and the second side wall 1806b. The carabiner 1802 may also include a divider 1808 fixedly coupled to the first side wall 1806a and the second side wall 1806b. In some embodiments, the divider 1808 is configured to extend at a diagonal between the first side wall 1806a and the second side wall 1806b, as demonstrated in FIG. 18. The divider 1808 may instead extend straight across such that it is substantially parallel with the third side wall 1806c.

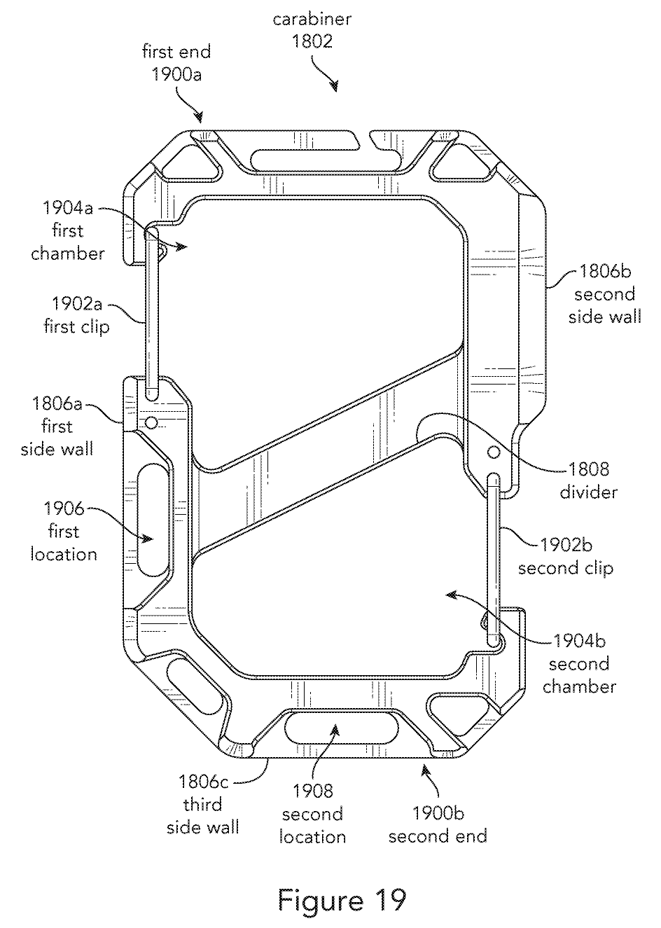

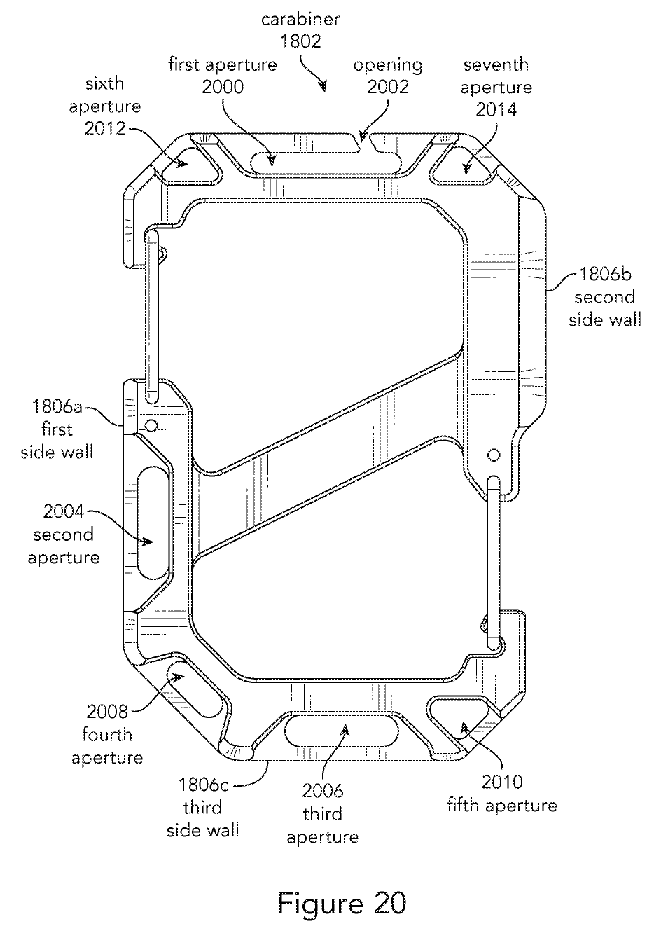

FIGS. 19 and 20 both show front views of the carabiner 1802, but highlight different features. FIG. 19 identifies the first clip 1902a and the second clip 1902b, as well as the first chamber 1904a and the second chamber 1904b. In some embodiments, the first clip 1902a and the first chamber 1904a are located adjacent the first end 1900a of the carabiner 1802, while the second clip 1902b and the second chamber 1904b are located adjacent the second end 1900b.

Similar to the other carabiners 702, 1602 included in this disclosure, the first clip 1902a may be configured to provide access to the first chamber 1904a, and the second clip 1902b may be configured to provide access to the second chamber 1904b. However, rather than needing to access the first chamber 1904a before reaching the second chamber 1904b—as with the carabiners 702, 1602—the second chamber 1904b may be accessed independently of the first chamber 1904a. In some embodiments, the first clip 1902a is located along the first side wall 1806a of the carabiner 1802, and the second clip 1902b is located along the second side wall 1806b of the carabiner 1802. The separate locations of the clips 1902a, 1902b may allow the user to independently access each chamber 1904a, 1904b. Further, in some embodiments, the divider 1808 is configured to separate the first chamber 1904a from the second chamber 1904b. The first chamber 1904a and the second chamber 1904b may be substantially the same size. In some embodiments, the first chamber 1904a is larger than the second chamber 1904b. The first chamber 1904a may be smaller than the second chamber 1904b.

As shown in FIG. 18, the shackle 1804 may be configured to couple to the carabiner 1802 along the third side wall 1806c. Though not shown in the Figures, the shackle 1804 may also be configured to couple to the carabiner 1802 along the first side wall 1806a. These two possible coupling locations are represented in FIG. 19 as the first location 1906, along the first side wall 1806a, and the second location 1908, along the third side wall 1806c. The shackle 1804, like the shackle 1604 of the carrying device 1600 and the shackle 704 of the carrying device 700, may be configured to detachably couple to the carabiner 1802 so that the carabiner 1802 and the shackle 1804 can be used independently or together as a unit.

FIG. 20 shows another front view of the carabiner 1802 and includes the first side wall 1806a, the second side wall 1806b, and the third side wall 1806c. Similar to the carabiner 702, 1602, the carabiner 1802 may include a plurality of apertures for attaching the shackle 1804 and/or various other attaching mechanisms such as, but not limited to, key rings, tethers, clips, lanyards, and the like. In some embodiments, the first aperture 2000 includes an opening 2002, as illustrated in FIG. 20. The opening 2002 may enable a user to couple the carabiner 1802 to a belt loop, bag strap, gear loop, or similar via the first aperture 2000. The second aperture 2004 and the third aperture 2006 may be configured to receivably couple the shackle 1804 to the carabiner 1802. As discussed with reference to FIG. 19, the shackle 1804 may be configured to couple to the carabiner 1802 at a first location 1906 (i.e., the second aperture 2004) or a second location 1908 (i.e., the third aperture 2006).

In addition to the first, second, and third apertures 2000, 2004, 2006, the carabiner 1802 may include a fourth aperture 2008 located between the second aperture 2004 and the third aperture 2006. Further, the carabiner 1802 may include a fifth aperture 2010 located adjacent the third aperture 2006 in a corner opposite the fourth aperture 2008. In some embodiments, the carabiner 1802 also includes a sixth aperture 2012 and a seventh aperture 2014. Any of the second aperture 2004, the third aperture 2006, the fourth aperture 2008, the fifth aperture 2010, the sixth aperture 2012, and the seventh aperture 2014 may be configured to couple to one or multiple attaching mechanisms such as, but not limited to, key rings, tethers, clips, lanyards, and the like. Further, the apertures may define any shape, including, but not limited to, long ovals, short ovals, triangles, rectangles, circles, and the like.

FIGS. 21 and 22 are focused on the shackle 704. It should be noted that though the reference label “704” is specifically used in FIGS. 21 and 22, the shackle 704 may be thought of as representing the shackle 704, the shackle 1604, and the shackle 1804. In some embodiments, the shackle 704, the shackle 1604, and the shackle 1804 are all substantially the same size with substantially the same features.

As discussed with reference to FIG. 9, the shackle 704 may comprise a first end 900a and a second end 900b located opposite the first end 900a. In some embodiments, the shackle 704 includes a first arm 2102a and a second arm 2102b, as shown in FIG. 21. The shackle 704 may also include a first screw 902 and a second screw 904. In some embodiments, the first screw 902 is configured to couple the first end 900a of the shackle 704 to the second end 800b of the carabiner 702 (or the second end 1700b of the carabiner 1602, or the second end 1900b of the carabiner 1802). The second screw 904 may be configured to detachably couple from the second end 900b in order to receive at least one key 2100, as shown in FIG. 21. For example, the second screw 904 may be configured to thread through the first arm 2102a, through the at least one key 2100 and/or a keyring, and through the second arm 2102b of the shackle 704, thereby coupling the at least one key 2100 and/or keyring to the shackle 704. The second screw 904 may include an opening for a pin or similar mechanism to ensure secure coupling to the shackle 704. In some embodiments, the first screw 902 and the second screw 904 comprise thumb screws configured to threadably couple to the shackle 704.

FIG. 21 also includes a directional indicator showing a first direction, a second direction, and a third direction. In some embodiments, the second screw 904 extends through the first arm 2102a and the second arm 2102b along the first direction, and the first screw 902 extends through the shackle 704 along the second direction. Each of the first arm 2102a and the second arm 2102b may extend along the third direction, as demonstrated. In some embodiments, the third direction is perpendicular to the first direction, and the second direction is perpendicular to both the first direction and the second direction.

FIG. 22 shows a side view of the shackle 704. In some embodiments, the shackle 704 defines a front side 2200, a back side 2202 located opposite the front side, and a channel 2204 extending between the front side 2200 and the back side 2202. The channel 2204 may be configured to receive a portion of the carabiner 702, 1602, 1802 to thereby couple the shackle 704 to the carabiner 702, 1602, 1802. For example, the channel 2204 may be configured to receive the second aperture 808 of the carabiner 702, the first aperture 1706 of the carabiner 1602, the second aperture 2004 of the carabiner 1802, and/or the third aperture 2006 of the carabiner 1802. When the channel 2204 receives an aperture, the first screw 902 may be configured to extend through the front side 2200 of the shackle 704, the aperture, and the back side 2202 of the shackle 704.

In some embodiments, the first arm 2102a of the shackle 704 includes a first hole 2206a, and the second arm 2102b of the shackle 704 includes a second hole 2206b. The first hole 2206a and the second hole 2206b may be configured to receive the second screw 904. In some embodiments, similar to the second screw 904, the channel 2204 extends along the first direction.

FIG. 23 shows a perspective view of the carabiner 702 coupled to several attaching mechanisms 2300. For example, in some embodiments, the first aperture 806 is configured to receive an attaching mechanism 2300a. The attaching mechanism 2300a may comprise a gear loop, the strap of a bag, a clip, a keyring, a chain, a lanyard, or a cord, as illustrated. As discussed throughout this disclosure, the first chamber 804a and the second chamber 804b may both be configured to couple to attaching mechanisms. For example, the first chamber 804a may couple to an attaching mechanism 2300b comprising a keyring with a set of building keys, as demonstrated in FIG. 23. Similarly, the second chamber 804b may couple to an attaching mechanism 2300c comprising a keyring with a car key, as shown.

The third aperture 906 and the fourth aperture 908 may be configured to couple to an attaching mechanism 2300d and an attaching mechanism 2300e, respectively. The attaching mechanisms 2300d, 2300e may comprise cords, lanyards, keyrings, clips, tethers, chains, gear loops, bag straps, and the like. It should be noted that anyone or multiple of the first aperture 806, the first chamber 804a, the second chamber 804b, the third aperture 906, and the fourth aperture 908 may couple to multiple attaching mechanisms. FIG. 23 also includes the outside environment 2302, which is meant to include the environment surrounding the carabiner 702. As discussed previously, the second chamber 804b may be separated from the outside environment 2302 by the first chamber 804a such that the attaching mechanism 2300c may pass through the first chamber 804a before reaching the second chamber 804b, thereby reducing the chance of accidentally releasing the attaching mechanism 2300c into the outside environment 2302.

Further, though FIG. 23 shows the carabiner 702, the carabiner 1602 and/or the carabiner 1802 may also be configured to couple to attaching mechanisms as demonstrated in FIG. 23. Any of the apertures and chambers of the carabiner 1602 and/or the carabiner 1802 may be configured to couple to one or multiple attaching mechanisms including, but not limited to, keyring(s), clip(s), tether(s), lanyard(s), chain(s), cord(s), gear loop(s), bag strap(s), belt loop(s), and the like.

The carabiner 702, 1602, 1802, and the shackle 704, 1604, 1804 may comprise metallic materials. The metallic materials may comprise any one or a combination of aluminum, titanium, and stainless steel. A person of ordinary skill in the art will understand that many different materials may be suitable for use in constructing the carrying devices 700, 1600, 1800.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely” or “nearly completely.” For example, the disclosure includes, “The first chamber 804a and the second chamber 804b may be substantially the same size.” In this context, “substantially the same size” is used to mean that the first chamber and the second chamber may be exactly the same size or may be close to, but not exactly, the same size.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A carrying device, comprising:
a carabiner comprising one or more clips, wherein the carabiner further comprises:
a first end defining a first aperture,
a second end located opposite the first end, wherein the second end defines a second aperture, wherein the first aperture is spaced apart from the second aperture in a first direction,
a first edge comprising a plurality of ridges defined along the first edge, and
a second edge comprising a bottle opener defined along the second edge, wherein the second edge is located opposite the first edge;
a shackle configured to detachably coupled to the carabiner, wherein the first end of the shackle comprises a front side, a back side located opposite the front side, and channel extending between the front side and the back side; and
a first screw configured to extend through the front side of the shackle, the second aperture of the carabiner, and the back side of the shackle, wherein the first screw is configured to extend through the second aperture in a second direction that is substantially perpendicular to the first direction.

2. The carrying device of claim 1, wherein the plurality of ridges are serrated ridges.

3. The carrying device of claim 1, wherein the one or more clips comprises a first clip configured to open to allow access to a first chamber and second clip configured to open to allow access to a second chamber located adjacent to the first chamber.

4. The carrying device of claim 3, wherein the first clip is connected to the first edge of the carabiner, and wherein the first clip and the first edge form a first side of the carabiner, wherein the second edge is part of a second side of the carabiner located opposite the first side.

5. The carrying device of claim 3, wherein the first clip is configured to separate the first chamber from an outside environment and the second clip is configured to separate the first chamber from the second chamber.

6. The carrying device of claim 3, wherein the first chamber is larger than the second chamber.

7. The carrying device of claim 1, further comprising a second screw configured to coupled to the second end of the shackle, wherein the second end of the shackle comprises a first arm having a first hole and a second arm having a second hole.

8. The carrying device of claim 7, wherein the second screw is configured to extend through the first hole, through at least one key, and through the second hole, thereby coupling the at least one key to the second end of the shackle.

9. The carrying device of claim 1, wherein the carabiner further comprises a third aperture located adjacent the first aperture and a fourth aperture located adjacent the second aperture, wherein the third aperture and the fourth aperture are each configured to receive at least one attaching mechanism.

10. The carrying device of claim 1, wherein the shackle comprises a first end and a second end located opposite the first end, wherein the first end is configured to detachably couple to the carabiner, and wherein the second end is configured to receive at least one key.

11. A carrying device, comprising:
a carabiner comprising one or more clips, wherein the carabiner comprises a first end defining a first aperture and a second end located opposite the first end, wherein the second end defines a second aperture, wherein the first aperture is spaced apart from the second aperture in a first direction;
a shackle configured to detachably coupled to the carabiner, wherein the first end of the shackle comprises a front side, a back side located opposite the front side, and channel extending between the front side and the back side;
a first screw configured to extend through the front side of the shackle, the second aperture of the carabiner, and the back side of the shackle, wherein the first screw is configured to extend through the second aperture in a second direction that is substantially perpendicular to the first direction.

12. The carrying device of claim 11, wherein the one or more clips comprises a first clip configured to open to allow access to a first chamber and second clip configured to open to allow access to a second chamber located adjacent to the first chamber.

13. The carrying device of claim 12, wherein the first clip is configured to separate the first chamber from an outside environment and the second clip is configured to separate the first chamber from the second chamber.

14. The carrying device of claim 12, wherein the first chamber is larger than the second chamber.

15. The carrying device of claim 11, further comprising a second screw configured to be coupled to the second end of the shackle, wherein the second end of the shackle comprises a first arm having a first hole and a second arm having a second hole.

16. The carrying device of claim 15, wherein the second aperture extends along a first direction, wherein the first screw extends along a second direction perpendicular to the first direction, wherein the first arm and the second arm each extend along a third direction perpendicular to the first direction and the second direction, and wherein the second screw extends through the first arm and the second arm along the first direction.

17. The carrying device of claim 15, wherein the first screw comprises a first thumb screw and the second screw comprises a second thumb screw.

18. The carrying device of claim 15, wherein the second screw is configured to extend through the first hole, through at least one key, and through the second hole, thereby coupling the at least one key to the second end of the shackle.

19. The carrying device of claim 11, wherein the carabiner further comprises a third aperture located adjacent the first aperture and a fourth aperture located adjacent the second aperture, wherein the third aperture and the fourth aperture are each configured to receive at least one attaching mechanism.

20. The carrying device of claim 11, wherein the shackle comprises a first end and a second end located opposite the first end, wherein the first end is configured to detachably couple to the carabiner, and wherein the second end is configured to receive at least one key.
